(19) United States
(12) Patent Application Publication
(10) Pub. No.: US 2024/0252978 A1
(43) Pub. Date: Aug. 1, 2024

(54) Component Separation from Gas Streams

(71) Applicant: Sustainable Energy Solutions, Inc., Ball Ground, GA (US)

(72) Inventor: Larry Baxter, Orem, UT (US)

(21) Appl. No.: 18/423,547

(22) Filed: Jan. 26, 2024

Related U.S. Application Data
(60) Provisional application No. 63/481,916, filed on Jan. 27, 2023.

(51) Int. Cl. B01D 53/14; B01D 3/40; B01D 53/00; B01D 53/18; B01D 53/26

(52) U.S. Cl. CPC B01D 53/145; B01D 3/40; B01D 53/002; B01D 53/1406; B01D 53/1475; B01D 53/1493; B01D 53/18; B01D 53/263; B01D 53/265; B01D 2252/102; B01D 2252/2021; B01D 2252/204; B01D 2257/504; B01D 2257/80

(57) ABSTRACT

A system and method separate a process fluid stream into a liquid-phase carbon dioxide stream and a carbon dioxide-depleted stream containing the remaining light gases. The system and method use a drying heat exchanger to contact the process fluid stream with a dryer contact liquid to remove moisture from a process fluid stream. The gaseous process fluid stream is separated from the wet dryer contact liquid stream and is directed to an extraction heat exchanger where it is contacted with an extraction contact liquid so that carbon dioxide is removed from the process fluid stream with a treated process fluid stream and a carbon dioxide enriched extraction contact liquid stream being formed.

### CLAIM OF PRIORITY

This application claims the benefit of U.S. Provisional Patent Application No. 63/481,916, filed Jan. 27, 2023, the contents of which are hereby incorporated by reference.

### FIELD OF DISCLOSURE

The present disclosure relates generally to systems and methods for purifying gases and, more particularly, to systems and methods for carbon capture.

### BACKGROUND

Gas separation into separate streams of differing composition has long been a major component of industrial processes and the advent of climate change mitigation technologies further increases this importance. Carbon capture, or separation of CO₂ from other light gases, looms large among the important new technologies. Typical streams requiring carbon capture include process fluid flows from industrial processes such as cement and lime production, steel production, refinery operations, and heat plants as well as utility power generation exhaust streams. The combustion fuel sources include coal, natural gas, liquid hydrocarbons, black liquor, biomass, industrial and municipal waste streams, and similar streams comprising CO₂ mixed with other light gases. These fuels and the technologies used to consume them produce combustion flue gas with varied composition. Combustion using air leads to most of the flue gas consisting of nitrogen. The non-nitrogen flue gas consists mostly of carbon dioxide, water, and unconsumed oxygen. Small amounts of carbon monoxide, nitrogen oxides, sulfur oxides, and trace amounts of hundreds of other chemicals are present, depending on the source. Entrained dust, ash, and soot will also be present in most combustion flue gas streams.

The separation of carbon dioxide from other light gases such as nitrogen is called carbon capture and is important for reducing carbon dioxide emissions and their associated environmental impacts. Environmental and climate scientists identify this carbon dioxide as the major, but not sole, source of changing global climate. Therefore, there is a clear need for efficient methods of capturing carbon dioxide from flue gases to produce a concentrated stream of carbon dioxide that can readily be transported to a safe storage site or to a further application, preventing its release to the atmosphere.

Carbon capture is, in concept, similar to removing other more traditional pollutants, such as oxides of nitrogen and sulfur, ozone, and carbon monoxide from emission sources. However, carbon capture requires much more energy, capital investment, and operating cost than these other treatments because of its quantity and the difficulty of its separation, among other things. Cost-effective carbon capture requires new systems and methods are needed to improve energy efficiency and/or provide other operational advantages for carbon capture technologies.

Mixed gas streams, such as flue gas, syngas, producer gas, natural gas, and refinery off gases, tend to contain moisture in varying amounts as do the vitiated flows discussed above. Moisture removal plays a major role in both traditional carbon capture and in many additional gas processing systems. For example, without water removal, the typically cryogenic temperatures of natural gas liquids recovery during natural gas processing can result in ice forming in the unit operations. Methods for water removal are extremely varied, including fixed bed adsorption via mole sieves, distillation, ice making, and even desiccation. All of these methods have one or several undesirable characteristics, including high energy usage, batch operations, poor scaling to large systems, or high capital and operating costs.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a system for separating carbon dioxide from a process fluid stream includes a process fluid feed line and a dryer contact liquid feed line. A drying heat exchanger has a combined stream cooling passage and a refrigeration passage. A junction is configured to combine a process fluid from the process fluid feed line and a dryer contact liquid from the dryer contact liquid feed line so that a combined stream is formed and directed to the combined stream cooling passage. The combined stream cooling passage and the refrigeration passage are configured so that a coolant stream in the refrigeration passage reduces a temperature of the combined stream so that water is condensed from the process fluid into the dryer contact liquid. A combined stream phase separator is configured to receive and separate the combined stream from the combined stream cooling passage into a gaseous process fluid stream and a wet dryer contact liquid stream. An extraction heat exchanger has a carbon dioxide extraction cooling passage and an extraction heat exchanger refrigerant warming passage. The carbon dioxide extraction cooling passage comprises two phases in direct contact, that gas phase entering through a gaseous process fluid inlet and exiting from treated process fluid outlet, and a liquid phase in contact with this gas phase entering through an extraction contact liquid inlet and exiting through a carbon dioxide enriched extraction contact liquid outlet. The extraction heat exchanger also includes an indirect-contact refrigerant passage configured to receive a first refrigerant or a second refrigerant that controls the temperature profile in the extaction heat exchanger. A gaseous process fluid line is configured to direct gaseous process fluid from the combined stream phase separator to the gaseous process fluid inlet of the carbon dioxide extraction cooling passage of the extraction heat exchanger. The carbon dioxide extraction cooling passage of the extraction heat exchanger is configured so that extraction contact liquid therein contacts gaseous process fluid so that carbon dioxide is extracted from the gaseous process fluid to form a treated process fluid and a carbon dioxide enriched extraction contact liquid, where the treated process fluid exits the carbon dioxide extraction cooling passage through the treated process fluid outlet and the carbon dioxide enriched extraction contact liquid exits the carbon dioxide extraction cooling passage through the carbon dioxide enriched extraction contact liquid outlet.

In another aspect, a system for separating carbon dioxide from a flue gas stream includes a process fluid feed line and an extraction heat exchanger having a carbon dioxide extraction cooling passage and an extraction heat exchanger refrigerant warming passage. The carbon dioxide extraction cooling passage has a process fluid inlet in fluid communication with the process fluid feed line, a treated process fluid outlet, an extraction contact liquid inlet configured to receive an extraction contact liquid and a carbon dioxide enriched extraction contact liquid outlet.

The carbon dioxide extraction cooling passage of the extraction heat exchanger is configured so that extraction contact liquid therein contacts process fluid so that carbon dioxide is extracted from the process fluid to form a treated process fluid and a carbon dioxide enriched extraction contact liquid, where the treated process fluid exits the carbon dioxide extraction cooling passage through the treated process fluid outlet and the carbon dioxide enriched extraction contact liquid exits the carbon dioxide extraction cooling passage through the carbon dioxide enriched extraction contact liquid outlet.

In still another aspect, a method for separating carbon dioxide from a process fluid stream includes the steps of combining a process fluid stream and a dryer contact liquid stream to provide a combined stream; directing the combined stream through a drying heat exchanger; cooling the combined stream in the drying heat exchanger by warming a coolant stream; condensing water from the process fluid stream into the dryer contact liquid stream in the drying heat exchanger; separating the combined stream into a gaseous process fluid stream and the wet dryer contact liquid stream; contacting the gaseous process fluid stream with an extraction contact liquid stream within an extraction heat exchanger so that carbon dioxide is transferred from the gaseous process fluid stream to the extraction contact liquid and a treated process fluid stream and a carbon dioxide enriched extraction contact liquid stream are produced; warming a first refrigerant or a second refrigerant within the extraction heat exchanger so that the contacting gaseous process fluid stream and the extraction contact liquid stream are cooled in the extraction heat exchanger.

### BRIEF DESCRIPTION OF DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration. In general, the flow diagrams follow common conventions such as stream inlet and exit temperatures in heat exchangers increase with increasing vertical height in the exchanger, liquids flow in and out of towers from top to bottom while gases flow in opposite directions, and streams flow into the center of pumps and out from the periphery. Stream numbers increase in the direction of stream flow but generally are not strictly consecutive (that is, they routinely skip some numbers) to allow process modifications without major renumbering large numbers of streams. The first number of a typically 3-digit stream number indicates the major flow loop or composition of that stream, as described below. However, these conventions are only qualitative and not rigorously imposed.

FIG. 1 is a process flow diagram showing a system for separating carbon dioxide from a process fluid stream.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the terms “communication”, “communicating”, and the like generally refer to fluid communication unless otherwise specified.

As used herein, the terms, “high”, “middle”, “warm”, “cold” and the like are relative to comparable streams, as is customary in the art.

As used herein, “condensing” is meant to refer to the process of a vapor being cooled to a liquid. As used herein, “desublimating” is meant to refer to the process of a vapor being cooled to a solid. As used herein, “cryogenic” is intended to refer to temperatures below about −58° F. (−50° C.).

As used herein, “dried” or “dry” is meant to refer to a gas or liquid stream that has had water removed, such as when a process fluid is dried to remove water vapor, resulting in a dried process fluid stream.

As used herein, “depleted” is meant to refer to a gas or liquid stream that has had a component removed, such as carbon dioxide. A process fluid stream that has had carbon dioxide at least partially removed is a depleted process fluid stream.

As used herein, “wet” is meant to refer to a gas or liquid stream that has had water added, such as when a contact liquid captures water and becomes a wet contact liquid, or a stream containing moisture that has not yet been removed, as in a wet process fluid stream.

As used herein, “enriched” is meant to refer to a gas or liquid stream that has had a component added, such as when a contact liquid captures carbon dioxide and becomes an enriched contact liquid.

As used herein, and as known in the art, a heat exchanger is a single device, multiple devices or an area or areas in the device or devices wherein heat exchange occurs between two or more streams at different temperatures, or between a stream and the environment. Heat exchangers can be either direct contact devices, in which fluids of two different phases are in physical contact, or indirect contact devices, in which fluids exchange heat through a barrier that separates their flows in different channels. As used herein, the terms “communication”, “communicating”, and the like generally refer to fluid communication unless otherwise specified.

Combustion flue gas consists of the vitiated flow from a fuel-fired device that carries away products of at least partial oxidation of the fuel by an inlet gas. The inlet gas is commonly air, but that is not a limitation of this invention and the oxidizing agent could be pure oxygen, CO₂ or H₂O in a producer or syngas, or other common oxidizing agents. The combustion fuel sources include coal, hydrocarbons, natural gas, waste, black liquor, biomass, combinations of these or these fuels combined with non-carbon-containing fuels such as hydrogen and ammonia. Combustion flue gas varies greatly in composition depending on the method of combustion and the fuel. Combustion in pure oxygen produces little to no nitrogen in the flue gas. Combustion using air leads to the majority of the flue gas consisting of nitrogen. The non-nitrogen flue gas consists of mostly carbon dioxide, water, and sometimes unconsumed oxygen. Small amounts of carbon monoxide, nitrogen oxides, sulfur dioxide, hydrogen sulfide, and trace amounts many other chemicals are present, depending on the source. Entrained dust and soot will also be present in most combustion flue gas streams. The method disclosed applies to any combustion flue gases. Dried combustion flue gas has had the water removed.

Syngas consists of a mixture substantially comprising hydrogen, carbon monoxide, water vapor, and carbon dioxide, possibly with additional nitrogen, argon, or other gases. Typically, a syngas produces a different product through a synthesis process such as Fische-Tropsch synthesis producing a liquid or waxy product.

Producer gas consists of a fuel gas manufactured from materials such as coal, wood, black liquid, biomass or similar fuels or syngas. It substantially comprises carbon monoxide, water, hydrogen, tars, and carbon dioxide possibly with additional other gases present.

Steam reforming is the process of producing hydrogen, carbon monoxide, and other compounds from hydrocarbon fuels, including natural gas. The steam reforming gas referred to herein consists primarily of carbon monoxide and hydrogen, with varying amounts of carbon dioxide and water.

Light gases include gases with higher volatility than water, or, more specifically, gases that do not condense at typical ambient pressures and temperatures. These include hydrogen, helium, carbon dioxide, nitrogen, argon, methane, ethane, and oxygen. This list is for example only and should not be implied to constitute a limitation as to the viability of other gases in the process. Specifically, references in this document to CO₂ in light gases means gases more volatile than (lighter than) CO₂, A person of skill in the art would be able to evaluate any gas as to whether it is a light gas in the context of this document.

Refinery off-gases comprise gases produced by refining petroleum and other hydrocarbons or precious metals, such as gold and silver. These off-gases may contain significant amounts of condensable material such as hydrocarbons with more than two carbon atoms, trace pollutants often containing sulfur, nitrogen, chlorine, or heavy metals, including but not limited to mercury and arsenic.

As used herein, a sensible heat exchanger/dryer (SHED) is a type of heat, mass, or heat and mass exchanger, an embodiment of which is described in greater detail below. In summary, a contact liquid stream passes into the first channels of an exchanger in a manner that the contact liquid stream wets the surfaces of the first channels but leaves an open volume in the first channels for a gas stream to pass. Preferably, the contact liquid stream flowrate suffices to produce a ratio of the contact liquid stream to the water to be removed high enough that the mixture of water and contact liquid does not form solids, though this is not a limitation and some solids formation is allowable. Also preferably, the contact liquid forms a continuous flow on all portions of the channel surfaces, though this is also not a limitation. The gas stream, passing co-current, counter-current, or cross current, relative to the contact liquid and directly contacts the contact liquid regardless of the contacting pattern (co-, counter-, or cross-current). Preferably, the gas stream forms a continuous phase in the bulk flow while the liquid stream forms a continuous phase on the surface, though an intermittent gas phase in the bulk (bubble mode) is allowed as is an intermittent liquid stream (spray mode). Heat, mass, or, most typically, heat and mass exchange between the gas and the contact liquid stream. Specifically, water and other vapors in the gas condense or absorb in or, in some cases, vaporize and desorb from, the contact liquid stream, changing the chemical composition of both the liquid and vapor. The second channel of the exchanger carries a cold liquid or refrigerant that indirectly exchanges heat with the first channel, cooling the contact liquid stream. An optional third channel carries a third stream such as a refrigerant, any cold process stream, or a returning, H₂O and CO₂ depleted or gaseous process fluid stream flowing countercurrent to the wet process fluid stream and warming as the wet stream cools. As the wet and gaseous process fluid streams commonly have different flow rates, an optional fourth (or more) stream helps balance the heat exchanger such that it preferably maintains a near-constant temperature difference between the warming and the cooling streams, though non-constant temperature differences are allowed. These streams help regulate the temperatures of the gas and liquid streams and, combined with the gas at contact liquid inlet temperatures, establish or maintain a desired temperature profile in the heat exchanger that facilitates drying or gas absorption.

As used herein, a latent heat and CO₂ extractor (LHANCE) is a type of heat, mass, or heat and mass exchanger, an embodiment of which is described in greater detail below. In summary, a contact liquid stream passes into the first channels of an exchanger in a manner that the contact liquid stream wets the surfaces of the first channels but leaves a volume in the first channels for a gas stream to pass. The gas stream, preferably passing counter-current to the liquid stream, conducts direct contact heat, mass, or heat and mass exchange with the contact liquid stream. Preferably, the contact liquid stream flowrate suffices to produce a ratio of the contact liquid stream to the CO₂ to be removed high enough that the mixture of CO₂ and contact liquid does not form solids, though this is not a limitation and some solids formation is allowable. Also preferably, the contact liquid forms a continuous flow on all portions of the channel surfaces, though this is also not a limitation. The gas stream, passing co-current, counter-current, or cross current, relative to the contact liquid and directly contacts the contact liquid regardless of the contacting pattern (co-, counter-, or cross-current). Preferably, the gas stream forms a continuous phase in the bulk flow while the liquid stream forms a continuous phase on the surface, though an intermittent gas phase in the bulk (bubble mode) is allowed. The second channel of the exchanger carries cold liquid or a refrigerant that indirectly exchanges heat with the first channel. The second channel regulates the temperature of the device by means of indirect heat conduction with the first channel. While CO₂ is the normal gas of choice for extraction, this invention can also extract other gases, including acid gases, from other gas streams. The amount of gas removal depends on the relative gas to liquid flow rates, the operating temperature, and the operating pressure in addition to the physical features of the exchanger (surface area, length, width, etc.).

The LHANCE and SHED share several characteristics, most notably both include liquid and gas streams within a single passage flowing co-, counter-, or cross-currently relative to each other. In a typical embodiment they differ in that the SHED utilizes heat recovery to help cool the wet process fluid stream as it warms the gaseous process fluid stream and it operates with a substantial temperature difference from the warm to the cold end (from the wet process fluid entrance to its exit) and with one primary design objective of removing moisture from the gas via condensation into the liquid while LHANCE can operate with a small temperature gradient in the flow-wise direction, perhaps almost isothermally, with one primary design objective of selectively removing CO₂ or some similar gaseous component from the gas stream. In some embodiments, both devices can combine to form a single heat exchanger with appropriate routing of the process fluid and contact liquid.

Both LHANCE and SHED can operate with solids formation. In these cases, the solids will form in the contact liquid stream of the exchanger. The portion of the exchanger where this liquid exits the device optionally transitions from a series of channels to an open drop tower through which the liquid falls as droplets through a continuous gas phase or as a bubbler in which gas bubbles through a continuous liquid phase. This allows solid formation on the liquid film/droplet/bubble surface, with the solids suspended in the liquid phase. The liquid and the suspended solids exit the device together for further processing.

Embodiments of the system and method of the disclosure separate a carbon dioxide-containing process fluid stream into a liquid-phase carbon dioxide stream of product standard purity (such as beverage-grade carbon dioxide, which is below 20 ppm H₂O and 30 ppm O₂, or some specifications for ship-laden CO₂, which require less than 10 ppm O₂) and a carbon dioxide-depleted stream containing the remaining light gases. The light gases could include N₂, O₂, or Ar in the case of treating a flue gas stream, H₂, CO or CH₄ in the case of treating a producer gas stream, syngas stream, or a natural gas stream, and H₂ in the case of treating a hydrogen production stream, or additional gases as dictated by specific applications.

Most process fluid streams, such as flue gas and the others listed, enter the process with some amount of moisture. A combination of water removal and carbon dioxide removal is also disclosed herein.

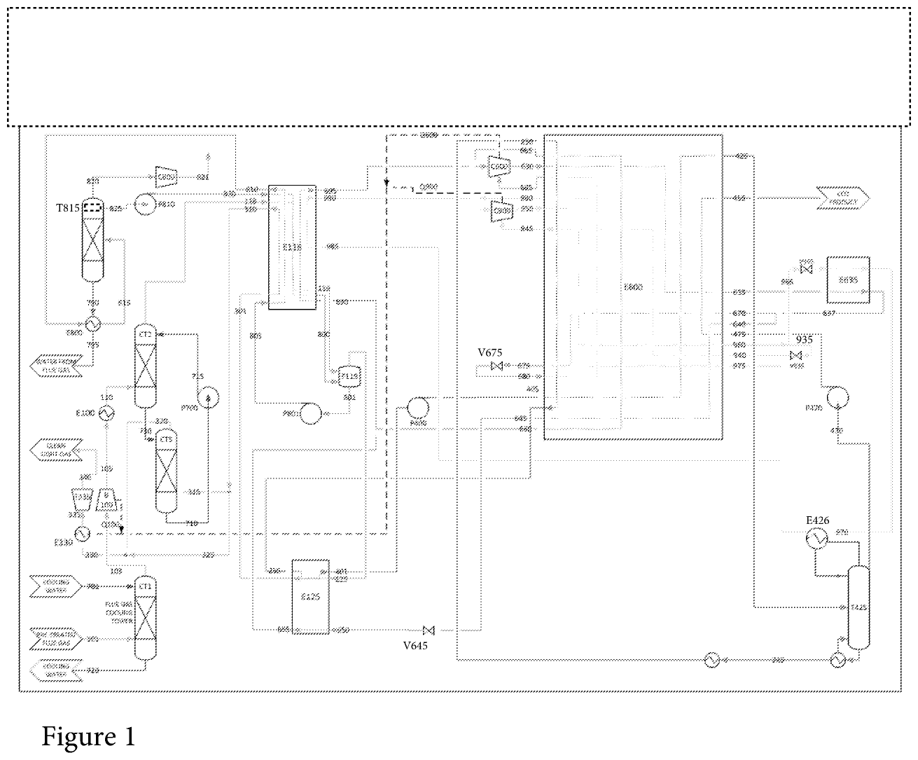

FIG. 1 illustrates a cryogenic carbon capture process and system in an embodiment of the system and method of the disclosure in the form of a process flow diagram with stream numbers organized to represent the primary flow streams.

### Process Fluid Loop

In FIG. 1, streams 100 through 199 correspond to the CO₂-laden process fluid loop while streams 300-399 correspond to the CO₂-depleted process fluid loop.

An initial process fluid stream 101 first cools to near ambient temperature in a process fluid cooling tower CT1 using cooling water 701, most typically in direct contact, though an indirect contact system is also allowed. During the cooling of the process fluid, a portion of the water condenses up to the equilibrium amount of water at the temperature and pressure of the CT1 water inlet stream 701 if the liquid and gases flow counter-currently, as would be common. Co-current or crosscurrent flows can also be used and may be preferable to mitigate the effects of, for example, acid gas condensation or solid particles. The process fluid cooling tower CT1 may be a heat exchanger or a conventional spray tower, packed column, or similar device with a direct contact liquid stream or an indirect-contact heat exchanger. The liquid is preferably water, but alternative cooling fluids may be used, including air as is used in installations where water is unavailable or constrained. Another alternative is to incorporate the process fluid cooling into the heat source for the distillation column reboilers either directly by using the bottoms flows from these columns or indirectly by transferring the heat to an intermediate fluid and using that fluid to heat the reboilers. The second arrangement has the disadvantage of lower overall heat transfer efficiency but the advantages of isolating the distillation column bottoms streams from the process fluid, which could be a safety, cost, or environmental issue if the bottoms streams are combustible/hazardous, expensive, or environmentally sensitive. The heat removed by water or other cooling stream may be used in other portions of this or other processes to, for example, provide reboiler heat, be released in a cooling tower or some other water-cooling system such as the sea, a lake, a stream, district heating, or other heat absorption systems.

Process fluids from many sources include contaminants such as particulate, NOx, SOx, HCl, NH₃, Hg, and similar species that present corrosion and environmental issues. These issues can be mitigated by materials, design, operations, and treatment provisions. Acid-gas heat exchangers are known in the industry and to those skilled in the art.

The cooled and partially dried process fluid stream 103 enters a blower B100 that sufficiently increases pressure so that the gas passes through the remaining equipment and can be vented to an ambient atmosphere or to a subsequent portion of a larger process. As an example only, blower B100 can provide a 0.1 to 0.5 bar pressure increase, depending on the details of the designs of the remaining equipment.

Optionally, the cooled process fluid can be substantially pressurized, with pressures that exceed those required to flow through the remaining system. This pressurization enhances the rate of moisture and CO₂ removal in subsequent steps and provides a pressurized clean gas stream that can then be expanded to produce energy near the end of the process. A significant advantage of pressurization is that the sub-ambient process stream can accumulate heat, including low-grade or waste heat, from other process steps or other processes, and convert this heat to work in the expander. The expander T335 shown in the process flow diagram provides an example of where this expansion could occur.

Process fluid pressurization by the blower generally increases the stream temperature (stream 105) slightly and an optional heat exchanger E100 can reduce the process fluid temperature to near ambient if desired.

As explained in greater detail below, the process fluid stream 110 enters a counter-current, direct contact heat exchanger CT2 that produces a cooler gaseous stream 118, for example with a temperature slightly above 0° C., by direct contact with a water stream 715. Liquid water stream 715 enters heat exchanger CT2 by pumping water stream 710 using pump P700.

Water stream 710 comes from the separate exchanger CT5, which is typically a direct-contact, counter-current exchanger with stream 730 from heat exchanger CT2 with the returning clean gas stream 315.

As further explained in greater detail below, both the treated process fluid stream 315 and untreated process fluid stream 110 exchange heat with water in a spray tower, packed tower, bubble column, or similar device (CT5 for treated gas and CT2 for untreated gas, respectively). The untreated process fluid (stream 110) loses moisture and some fraction of the contaminants such as particulate, NOₓ, SOₓ, HCl, NH₃, Hg, and similar species indicated earlier as it cools to near 0° C. (for example) to form stream 118 while the treated process fluid (stream 315), which exits CT5 as stream 320, gains a small amount of moisture as it warms by direct contact with the water, up to the limit of the equilibrium amount at the temperature and pressure of the process fluid exit.

Established industrial procedures tailored to the specific process fluid conditions remove the contaminants that accumulate in water stream 710 or 720 or both. These differ depending on the contaminants and are not shown in the flow diagram. Similarly, established procedures remove the excess water collected in CT1 and CT2 and provide makeup water for the water that vaporizes in CT5. The diagram also does not show these streams.

Stream 118 typically contains a small amount of water (for example, about 0.6% at near 0° C. and 1 bar) which must be removed. This may be accomplished in steady state drying heat exchanger E118, which performs both cooling and drying. As an example only, drying heat exchanger E118 may be a brazed aluminum heat exchanger. In the case of incompatible materials among the exchanger, the process fluid, and the contact liquid, stainless-steel or other materials may be used. As an alternative to drying heat exchanger E118, either a conventional mole sieve or similar dryer followed by a cooler may be used.

In the illustrated embodiment, heat exchanger E118 may include a sensible heat exchanger/dryer system, or SHED (previously described), that dries and cools the process fluid simultaneously. More specifically, and as illustrated in FIG. 1 within E118, the process fluid stream 118 combines with a dryer contact liquid stream 830 that both absorbs the moisture from stream 118 as it cools and prevents or suppresses water freezing in the temperature range of the heat exchanger. Streams 118 and 830 combine in heat exchanger E118 and may flow co-currently, counter-currently, or cross-currently in the same channel, though concurrent and countercurrent would be most common. In alternative embodiments, streams 118 and 830 may combine prior to entering heat exchanger 118 or in or near the heat exchanger header. In all cases, the system design encourages the liquid to run down internal walls/surfaces or channel walls (preferred) of heat exchanger E118, while the gas runs between the liquid-coated walls. This is done by, for example, spraying or otherwise introducing the liquid as a sheet directly on the surface of the heat exchanger header or channels, spraying dryer contact liquid in the header or in stream 118 just before it enters the exchanger, or just combining the liquid and gas streams without spraying. It is beneficial, and thus preferred but not required, that the dryer contact liquid not come into full chemical or thermal equilibrium with the untreated process fluid stream before both streams begin cooling. This is accomplished by minimizing the surface area and exposure time of the gas 118 and dyer contact liquid 830 streams as they are combined. The injection of dyer contact liquid 830 into the heat exchanger E118 should promote dyer contact liquid coating all surfaces of the channel of heat exchanger E118 containing both the dyer contact liquid 830 and process fluid 118 while minimally vaporizing the dyer contact liquid in the untreated process fluid stream.

Examples of suitable dyer contact liquids include one or combinations of alcohols, including but not limited to methanol, ethanol, and propanol, ketones, including but not limited to acetone and methyl—ethyl ketone, ethers, including but not limited to dimethyl ether, diethyl ether, methyl-ethyl ether, water in combination with these compounds, organic liquids miscible or immiscible with water, and inorganic fluids including ammonia and low-melting-point amines. Of these, alcohols and ketones have some advantages if they are also used later in the process, while methanol and ethanol solutions have lower minimum melting points than pure or aqueous ketone solutions and may be preferred if the minimum process temperature is near or below ketone-based fluid melting temperatures (nominally −95° C. to about −107° C.). A typical large-scale application might use commonly available materials such as methanol or methanol-acetone mixtures given their compatibility with subsequent process steps and their relative ease and low cost of acquisition.

While the process flow diagram of FIG. 1 illustrates the dyer alcohol liquid flowing co-currently with the untreated process fluid stream through heat exchanger E118, an alternative is for the dyer alcohol liquid and untreated process fluid to flow counter-currently within the same heat exchanger channel, with the liquid substantially flowing along the heat exchanger surfaces and the gas flowing between the liquid-coated surfaces. Co-current flow allows higher gas velocities in the heat exchanger since the velocity is not limited by potential entrainment of the liquid. Countercurrent flow offers potential advantages to both heat and mass transfer. However, the majority of heat transfer within heat exchanger E118 may occur between the process fluid stream 118 (which is cooled) and the cooling streams, which may include the treated process fluid stream 301 and streams 690 and 805 (all three of which are warmed), which makes the heat transfer between the moisture-absorbing dryer contact liquid stream and the untreated process fluid stream a less important consideration.

In one embodiment, the treated process fluid stream 301 provides much of the cooling required in heat exchanger E118, as illustrated in the process flow diagram. This type of heat recovery provides such an embodiment with high energy efficiency, but the heat recovery can be managed in other ways. For example, the streams that would otherwise provide heat integration in exchanger E600, including but not limited to streams 690, 805, and 405, can provide much or all of the cooling needed to cool stream 301 and many of these have the advantage of being liquid streams, which both decreases the size of exchanger E118 and, if fewer streams are used, decreases its complexity. Furthermore, the returning treated process fluid stream 301 typically has a lower flowrate than the entering wet process fluid stream 118 and therefore cannot efficiently provide all the cooling needed. Therefore, additional streams may be provided that help balance this cooling demand. Another alternative that is especially attractive in large-scale applications is to split heat exchanger E118 into two or more parallel heat exchangers, one (typically the larger) of which is balanced as just described and the others of which incorporate additional streams. The embodiments of this paragraph provide examples of obtaining heat integration among the several heat exchangers, but one skilled in the art could find alternative ways to do so.

Moisture absorbing dyer contact liquid stream 830 typically also absorbs some CO₂ as it cools and dries the process fluid within E118. As illustrated in FIG. 1, the combined streams 118 and 830 are phase-separated into a moisture depleted (dry) gaseous stream 119 and a moisture-enriched and possibly CO₂-enriched liquid stream 800. The FIGURE shows the steams separated inside heat exchanger E118. They can alternatively and probably more easily be separated by an external flash vessel or tank F119. This phase separation may happen entirely within heat exchanger E118, in both the heat exchanger E118 and the flash tank F119 (as illustrated in FIG. 1), or it may happen solely in the flash tank F119. In embodiments where the phase separation occurs solely in the heat exchanger E118, the flash tank F119 may be omitted.

This discussion will next follow the dryer contact liquid loop and then return to the process fluid stream. The short description of this loop is that the process distills the water and CO₂ collected in stream 801 and recycles the dryer contact liquid to the process. The distillation column reboiler can use waste heat from either the incoming process fluid stream 101 or the compressors or be separately heated. Finally, column T815 may operate at a range of pressures, including sub-ambient (vacuum) pressures, to optimize the separation and the heat integration. Heat integration may be provided to minimize cost and energy demand in a manner that would be known to one skilled in the art of heat integration and process engineering.”

The separated dryer contact liquid stream 801 increases pressure as it passes through pump P801 and then re-enters heat exchanger E118 as illustrated or, alternatively, E600, as stream 805 for warming (for example, warm back to near 0° C. or above), with resulting liquid stream 810 exiting heat exchanger E118 as an example. Liquid stream 810 warms further in heat exchanger E800 with a resulting warm stream 815 entering distillation column T815. Distillation column T815 separates moisture from the dryer contact liquid stream, with the H₂O exiting the column as stream 790. As illustrated in FIG. 1, water stream 790 warms stream 815 to reduce the load on the reboiler. The recovered dryer contact liquid stream 825 exits the distillation column T815 and recycles via pump P810 as stream 830 to heat exchanger E118 as previously described and completing its loop. A vapor stream 820 exits the distillation column as a vapor and contains primarily the contact liquid but also the CO₂ collected in T118. There is generally a small amount of CO₂, but it can be recovered and purified by separating the CO₂ from other possible impurities, which are typically N₂, O₂, and dryer contact liquid vapor. This purification uses technologies that would be familiar to one skilled in the art. T815 may pass through compressor C800 so it can combine with stream 830 or is vented as vapor stream 821. In alternative embodiments, a liquid-liquid extraction process or a reverse osmosis process or some combination of these with distillation may be used in place of distillation column T815. This system will also remove several contaminants from many process fluids, including hydrocarbons, particulate, NOₓ, SOₓ, HCl, NH₃, Hg, and all other compounds that condense or absorb at these cold temperatures in the exchanger. These contaminants leave the condensed phase flow in either dedicated purification systems common to the industry such as filtration, ion exchange, precipitation, chemical reaction, distillation, or similar established separation processes or in the CO₂ purification system described later.

With continued reference to FIG. 1, cooled and dried process fluid stream 125 flows from the vapor outlet of flash tank F119 to extraction heat exchanger E125, which extracts CO₂ from gas stream 125 into an extraction contact liquid stream 255 in direct contact with and flowing in the same channel with the gas. The heat exchanger E125 may take the form of a latent heat and CO₂ extractor (LHANCE), described previously. This contact liquid stream 255 preferably flows counter-currently to gas stream 125, as illustrated in FIG. 1. As these streams pass, the contact liquid stream 255 extracts CO₂ from the gas stream 125, possibly in combination with solids that form in the contact liquid stream, though preferably without forming solids. A separate channel within heat exchanger E125 contains a vaporizing or otherwise cooling refrigerant 650 that carries away the heat generated in the contact liquid 255 as the CO₂ transfers into it from the gas stream 255. The temperature profile of E125 can be controlled by stream 650, with an essentially constant temperature being especially efficient and useful. Use of a heat exchanger, E125 or LHANCE, performs a unit operation that would typically be done in an adsorption, distillation, or similar column. This heat exchanger combined with stream 650 allows independent control of the temperature profile in the exchanger, which allows the process to provide, for example, a nearly constant temperature profile in a unit operation that involves a phase change and the associated substantial heat transfer. In addition to managing the heat load of the phase change, this design allows a single-component refrigerant to provide the cooling, simplifying the refrigerant loop design and maintenance. The heat exchanger design, construction, and operation are all potentially simpler and less costly than that of a traditional column. This heat exchanger is the subject of a separate patent that is incorporated herein by reference.

The outlet streams for heat exchanger E125 include gas stream 301, which is depleted in CO₂ via E125 and moisture via E118, the contact liquid stream 401, which is enriched in CO₂, and a warmed refrigerant stream 655. In the illustrated embodiment, the system operates as a nearly isothermal heat exchanger, with a small temperature change both from the inlet to the outlet and between the streams in the exchanger. The temperature difference between the refrigerant stream 650 and the combined contact liquid and gas stream (255 and 125, respectively) is a design choice. The minimum of the value in the exchanger is called the minimum temperature approach (MITA), which occasionally can be less than 1° C. but generally ranges from 1° C. to 6° C., typically with the heat exchanger size decreasing as the MITA increases. The temperature change from the refrigerant inlet (650) to the outlet (655) also represents a design choice but can be as small as about 1° C. and is primarily driven by the pressure drop in the refrigerant channel, which slightly changes the refrigerant vaporization temperature. In other embodiments, the temperature change can be larger if the heat exchanger extracts a portion of the heat based on sensible energy change, uses a refrigerant mixture, or accepts and produces a gas stream at different temperatures. This system will also remove several contaminants from many process fluids, including hydrocarbons, particulate, NOₓ, SOₓ, HCl, NH₃, Hg, and all other compounds that condense or absorb at these cold temperatures in the exchanger. These contaminants leave the condensed phase flow in either dedicated purification systems common to the industry such as filtration, ion exchange, precipitation, chemical reaction, distillation, or similar established separation processes or in the CO₂ purification system described later.

The process fluid exits heat exchanger E125 depleted of CO₂ as stream 301 and other components less volatile than CO₂ and begins a process of warming by returning to, and passing through, heat exchanger E118, where it helps cool the incoming stream 119. Stream 301 remains cooler than stream 119 by an amount that affects the design and efficiency of the process. Designs could achieve a MITA low as 1° C., occasionally slightly lower, which optimizes exchanger efficiency at the cost of larger size/heat transfer surface area. MITAs in heat exchanger E118 could reach this low value or could be and preferably are higher to reduce the heat exchanger size and pressure drop and to deal with potentially varying process fluid flow rates, compositions, and pressures, making the overall process more robust to real-world operation.

The treated process fluid stream exits heat exchanger E118 as stream 310 at a temperature, for example, that is at or near 0° C. Stream 310 then splits into streams 315 and 325, with stream 315 having sufficient flow to cool water stream 730 to slightly above 0° C. in heat exchanger CT5 which, as indicated previously, may be a direct-contact heat exchanger, packed column, spray tower, or similar device. As indicated previously, the resulting cold-water stream 710 exits heat exchanger CT5 and then passes through pump P700, changing to stream 715 which enters heat exchanger CT2, which, as indicated previously, may also be a direct contact heat exchanger, packed column, spray tower, or similar device, where it cools the untreated process fluid stream 110 to near 0° C., as previously described.

The remainder of the treated process fluid stream 325 is recombined with the stream 370 to provide stream 330. Stream 330 may be optionally heated via heat exchanger 330 (to provide stream 335) using, for example, low-grade heat from this or other processes, and then expanded via expansion device T335, to provide clean light gas stream 340 suitable to be vented to the atmosphere. This stream 340 is a dry, CO₂-depleted and otherwise very clean stream but when the process is treating process fluid, it frequently will not contain insufficient O₂ to be released at ground level. It is most typically vented in the stack or other device in which the untreated stream 118 generally would have been released. Sufficient pressure must still be in stream 340 to exit this stack with adequate velocity to disperse in the ambient air. When the process is treating syngas, producer gas, natural gas, etc., stream 340 is a product stream that forms the inlet to a separate process.

### Contact Liquid and CO₂ Loop

As previously described, contact liquid stream 255 directly contacts the process fluid stream 125 in heat exchanger E125 where it primarily extracts CO₂. In a preferred embodiment, heat exchanger E125 includes at least one set of two-phase channels with process fluid and contact liquid flowing counter-currently to each other within the at least one set of channels of a multi-stream heat exchanger. Temperature control in E125 is preferably maintained by a separate refrigeration channel and the gas extraction frequently happens via adsorption rather than condensation. The choice of contact liquid 255 depends in part on its ability to absorb CO₂, especially in the operating scenarios that minimize solids formation, and in part on its materials compatibility, viscosity, and other practical considerations. Similar to E118 discussed previously, the phase changes in E125 would commonly occur in an absorption or distillation column containing packing or trays and the temperature profile would be dictated by the heat of absorption and the heat exchange of the counter-current liquid and gas streams in that column. In the illustrated embodiment, a heat exchanger rather than a column performs this unit operation, with one set of the channels in the exchanger containing two phases whose composition changes in the exchanger and with a separate refrigerant channel in the same exchanger controlling the temperature profile. A similar effect could be achieved with a column containing a series of pump-around coolers, and this is included in an alternative embodiment, but a pump-around system is more cumbersome than the heat exchanger system. This arrangement allows independent control of the composition and the temperature profiles and enables, for example, operation of an essentially isothermal absorption column or any other temperature profile suitable to the process.

Contact liquid stream 255 directly contacts the process fluid stream 125 typically inside the heat exchanger E125. In an embodiment, the liquid stream 255 enters near the top of the device and flows down the same channels that the process fluid stream 125 flows up. As they pass each other, CO₂ transfers from the gas to the liquid, with associated heat released in the liquid phase. The liquid and gas streams separate either in heat exchanger E125, as in the embodiment illustrated in FIG. 1, or immediately outside the exchanger. Heat exchanger E125 ideally operates with the contact liquid flowing counter-currently with the process fluid, but co-current flow is also possible and easier to implement, especially for streams with low initial CO₂ contents. A combination of co-current, counter-current, and cross current-flow patterns is also conceivable, especially if the exchanger includes different sections.

Absorbed and potentially solid CO₂ accumulates in contact liquid stream 255 as it and the process fluid stream 125 pass each other. The solids that form would primarily be CO₂ and can be carried out of the device and through the next portion of the process as a lightly-loaded slurry up to the point that the CO₂ melts.

The contact liquid stream absorbs some nitrogen and oxygen in heat exchanger E125 in addition to CO₂, pollutants less volatile than CO₂, and other compounds. Some of these compounds leave with the liquid phase, further decreasing deleterious compounds in the process fluid stream. The contact liquid is also chosen so only minimal as amounts vaporize in the process fluid stream the contact liquid and process fluid contact each other. The operating temperature also influences the amounts of materials that accumulate in the liquid stream and the amount of contact liquid that vaporizes in the process fluid stream. An optional flash separation device (not shown in FIG. 1) that the liquid stream enters after E125 removes some of these compounds that absorbed or condensed in the contact liquid at ambient or optionally at sub-ambient pressure. Other options exist for removing these species later in the purification process as described below.

The contact liquid containing CO₂ exits heat exchanger E125 as stream 401 and then increases in pressure within pump P400 to form stream 405, the pressure of which is high enough to maintain the CO₂ as a liquid as it warms in E600. Stream 405 warms in E600 and exits near ambient temperature as stream 425.

Stream 425 enters one or more distillation columns T425 wherein the CO₂ and contact liquid separate to form a CO₂ product stream 470 and process recycle contact liquid stream 245. Stream 245 cools back to near the operating temperature of E125 in heat exchanger E600 and becomes stream 255, which completes the contact liquid cycle.

The distillation column(s) T425 can deploy traditional staged, packed, or trayed columns. In alternative embodiments, distillation column(s) T425 may be replaced by one or some combination of at least a single one-stage and possibly multiple stage flash tanks, a liquid-liquid extraction column, a reverse osmosis system, or some combination of these to purify the CO₂ to the target specifications. In one embodiment, the feed and product streams of columns T425 and/or T815 pass through heat exchangers that modify their temperatures to within a minimum approach temperature of the feed stream, minimizing sensible energy loss in the system and thus maximizing its energy efficiency. Furthermore, the feed stream may be split into two streams that enter the column already partially separated and at appropriate temperatures for the column cold and warm ends. This makes the column more efficient in separating the components.

Small amounts of the contact liquid carry over as vapor or fume in the process fluid stream 301 exiting heat exchanger E125 and leave with the pure (or nearly pure) CO₂ stream 470 from distillation column(s) T425, and these represent the primary losses of contact liquid in the system, both of which are small. A makeup flow (not shown) compensates for these small losses.

A pump P470 pressurizes the CO₂ stream 470 to design pressure, which is usually 125-150 bar. Stream 475 exits pump P470 and cools in heat exchanger E600 forming cooled stream 455, which exits the system as the CO₂ product stream.

Ketones, alcohols, ethers, acetates and blends of these, possibly with some water, make good candidates for the contact liquid. Specifically, acetone or methanol/ethanol/propanol do not freeze in the temperature range of typical operation, absorb water in addition to CO₂, and have volatilities and viscosities suitable to this process. Several mixtures of these chemicals with each other and with H₂O or CO₂ exhibit eutectic behavior with melting points well below those of any single component, forming especially well-suited contact liquids. Acetone has an especially good ability to absorb CO₂ and makes an excellent candidate for use in E125. Acetone mixtures with small amounts (0-15%) of methanol also make excellent candidates and allow the E125 to operate at somewhat lower temperatures (−90 to −100° C.) than it would with pure acetone, which freezes at about −95° C. Methanol mixtures with water have especially low viscosities and freezing points and are good candidates for use in E118. Specifically, E118 preferably operates with sufficient methanol vapor at its warm end which is slightly above 0° C. prior to mixing with methanol, that condensates that form in the system contain enough methanol to remain above their freezing points at all temperatures and compositions in the exchanger.

Heat exchangers E118 and E600, as illustrated here, separate the wet process fluid stream 118 from the primarily refrigerant sensible heat exchange streams (E600) as the process fluid stream 118 may contain some minor components such as condensable acids and mercury that are incompatible with aluminum and other materials commonly used in E600. Furthermore, large-scale applications process process fluid volumetric flow rates that can make these exchanger as large as or potentially larger than are commonly available from manufacturers, and splitting them decreases their size. However, for smaller applications or when there are no materials issues, these exchangers can be combined or separated in different ways to minimize cost, maximize efficiency, simplify the process or otherwise lead to different flow diagrams than shown here. These alterative combinations would be apparent to one skilled in the art of industrial or utility heat exchange of the type.

### Refrigeration Cycles

The system of FIG. 1 uses traditional refrigeration cycles for cooling. The system of FIG. 1, however, is not traditional in that it accomplishes the cooling with just two refrigeration loops, both of which use single component refrigerants. This simplifies the process and decreases the capital expense and maintenance costs of the compressors and refrigeration loops. Alternatively, the system can use similar refrigeration cycles with mixed refrigerants, in which case the heat exchangers that primarily vaporize the singe refrigerants in this process flow diagram may be combined with the heat exchangers that primarily do sensible heat exchange.

The following sections describe one method of formulating the refrigeration loops for this system. There exist many alternative methods that would be evident to one skilled in the art.

### Heavy Refrigerant Loop (Loop 900)

The least volatile refrigeration loop preferably uses propane, propylene, or other fluids with similar volatilities as its working fluid. In an embodiment using propane as the refrigerant, the liquid propane enters the main refrigerant cooler E600 from compressor C900 as stream 955, where its temperature drops to about −40° C. to form stream 960. The compressor C900 is typically a multistage device with inter-stage cooling using cooling water, air, or other available means of carrying away compression heat. This heat can be integrated into the distillation column reboilers.

Stream 960 optionally splits to form stream 965 and optional stream 935 which passes through expansion valve V935 to form stream 940. Stream 965 passes through an expansion valve (as illustrated) or a turbine expander V965 where its pressure drops to near the bubble point (slightly over 1 bar) and it enters heat exchanger E635. Exchanger E635 partially vaporizes stream 965 to form two-phase stream 970 as it condenses the gas in stream 635 in the other refrigeration loop to form single-phase liquid stream 637, both processes preferably occurring at essentially constant temperature with a minimum temperature approach (MITA) determined by the exchanger design. The most efficient designs commonly operate with MITAs of about 1° C. for these two well-characterized streams.

The now mixed gas-liquid phase stream exits E635 as stream 970. Stream 970 provides cooling for the CO₂ purification process by, as illustrated in the process flow diagram, cooling the condenser E426 of the distillation column(s) T425 and forming stream 975. At this point, stream 975 comprises mostly vapor but with a typically small amount of residual liquid which aids in its ability to modify the temperature profiles in exchangers E600 and E118 as it warms back to ambient temperature. The stream splits into one stream for each of E600 and E118, forming streams 975 and 985.

Stream 975 enters E600 with a small residual liquid fraction and warms to ambient temperature as it helps to modify the temperature profile of E600 to maintain a small and reasonably constant minimum approach temperature in E600. Stream 975 exits E600 as stream 980.

As indicated above, stream 960 splits to form streams 965, described previously, and an optional stream 935 that passes through expansion valve V935 and enters exchanger E600 as stream 940 at a pressure where it begins to vaporize and preferably where it modifies the temperature profile to maintain a small and consistent temperature difference between the hot and cold streams, or minimum approach temperature, in E600. Its pressure is adjusted to match that of one of the intermediate stages of compressor C900, which is higher than the inlet pressure of compressor C900 and therefore it enters E600 as stream 945 and vaporizes at a somewhat higher temperature than does stream 965 and its downstream vaporization points. Stream 945 exits E600 near ambient temperature.

As previously indicated, stream 985 branches from stream 970 and enters E118, where it modifies the temperature profile to maintain a reasonably small and constant temperature differences. It exits E118 near ambient temperature as stream 990, which combines with stream 980 exiting heat exchanger E600 with the combined stream entering the low-pressure end of compressor C900 slightly above 1 bar (for example) so that stream 995 is produced and the heavy refrigerant loop is completed.

Some of the salient features of the 900 loop cycle include (a) it can contain a single rather than a mixed refrigerant, (b) it condenses to a liquid before entering E600, (c) its pressure never drops below ambient to avoid air from leaking into it, (d) it provides the cooling for both condensing the refrigerant from the 600 loop and for the CO₂ purification process, and (e) it helps shape the temperature profiles in both E600 and E118 to maintain constant and small temperature differences between the cold and the hot streams in these exchangers.

Cooling water that is less than about 18° C. can provide the cooling needed to condense the CO₂ in the distillation column T425, decreasing the amount of refrigerant needed to in loop 900 and improving overall energy efficiency. This requires adjusting the pressure of T425 such that CO₂ will condense at the temperature of the cooling water or, more specifically, at the temperature the cooling water can make the condenser operate.

### Light Refrigerant Loop (Loop 600)

The light or most volatile refrigerant loop (loop 600) primarily provides cooling to absorb the phase-change heat associated with CO₂ capture. This loop can operate with one of several single refrigerants, the choice of which depends on the temperature requirement of exchanger E125 and, more specifically, stream 650 but which would generally use one of ethylene, ethane, or propylene. The compressor C600 is typically a multistage device with inter-stage cooling using cooling water, air, or other available means of carrying away compression heat.

Stream 325, which is preferably at sub-ambient temperature, near 0° C., can optionally cool the last stage of C600 or C900 to sub-ambient temperatures to decrease the thermal load in E600 and/or the required exit pressure of at least one of the compressors. Stream 630 exits the compressor and enters E600 as a gas, cooling to near its dew point to form stream 635. Stream 635 enters E635 near its dew point and exits E635 near its bubble point as stream 637, having substantially condensed to a liquid in E635 with minimal temperature change (as previously noted). The pressure drop of the stream in E635 changes the bubble and dew point temperatures as the stream progresses through the exchanger, but this is a small change and E635 operates substantially as a constant-temperature condenser.

Stream 637 exits E635 as a liquid and splits into streams 640 and optionally 670.

Stream 640 cools in heat exchanger E600 to form liquid stream 645. The temperature of liquid stream 645 is a few degrees below the temperature at which CO₂ transfers into the contact liquid 255 in E125, which is typically between −80 and −98° C. Stream 645 passes through an expansion valve (illustrated) or expansion turbine V645 to form stream 650 with a pressure near its bubble point, which should be somewhat above ambient pressure. Stream 650 enters E125 as a substantially liquid stream and leaves as substantially vapor stream 655, with minimal change in temperature but substantial phase change in E125. From this point, the stream warms to near ambient temperature by cooling other streams.

Stream 655 splits to form streams 660 and 690 which pass through E600 and E118 respectively. A small amount of residual liquid in these streams helps to establish an adequate temperature difference in each heat exchanger as the liquid begins to vaporize. In E600, stream 660 warms to ambient temperature as it exchanges heat with cooled streams, exiting as stream 665 and joining with stream 695 to form the low-temperature inlet of C600. This completes the light refrigerant loop except for the branching streams, which are discussed next.

Optional stream 670 branches from stream 637 as a liquid stream near the condensation temperature of stream 635. The purpose of stream 670 and the rest of this branch is to help shape the temperature profile in E600 to maintain a constant and small temperature difference between the hot and cold streams. Stream 670 cools as a liquid in E600 and exits as stream 675, which is warmer than stream 645 and near the stream bubble point temperature at a one of the intermediate stage pressures of C600. Expansion valve or expander V675 reduces the pressure of stream 675 to near this same stage outlet pressure to form a substantially liquid stream 680. Stream 680 re-enters E600 and vaporizes as it warms back to ambient temperature. Stream 680 exits E600 as a vapor near one of the intermediate stage pressures of C600 to form stream 685 which enters the compressor at the inlet pressure of one of the intermediate stages of C600.

Optional stream 690 branches from stream 655, which helps shape a small and consistent temperature profile between the hot and cold streams in E118. Stream 690 is substantially, but not necessarily, complete vapor and enters E118 near the bottom of its temperature range. It warms to near ambient temperature to form stream 695 as an exiting stream from E118. Stream 695 mixes with stream 665 to form the low-pressure inlet stream for compressor C600.

Some of the salient features of the 600 loop cycle include (a) it can contain a single rather than a mixed refrigerant, (b) it condenses to a liquid by exchanging heat with loop 900, specifically stream 965 and those following it within E635, (c) its pressure never drops below ambient to avoid air from leaking into it, (d) it primarily provides the cooling for CO₂ extraction from the process fluid stream, and (e) it helps shape the temperature profiles in both E600 and E118 to maintain constant and small temperature differences between the cold and the hot streams in these exchangers.

### Waste Heat Recovery System

In some embodiments of the system of the disclosure, the primary power-consuming portions of the system are the blower (B100) and the compressors (C600 and C900). The compressors provide refrigerant and the blower provides process pressure to overcome pressure drop. The efficiency with which the blower overcomes process pressure drop increases as the blower inlet pressure increases. Similarly, if the blower boosts the pressure further than required, it can recover some of the energy by expanding the stream at the end of the process, as indicated by T335. The amount of recovered energy increases if the expanding stream is hotter than the incoming stream for the same reasons that a gas turbine or jet engine extracts more energy from the hot exhaust than is required to compress the cool inlet air. This is the function of heat exchanger E330. The amount of recovered energy depends on details of the flow, including the fraction of the flow removed in the carbon capture process, the pressure drop of the unit operations, and the amount of heat recovered. The primary sources of heat that could raise the gas temperature above its inlet temperature include the hot process fluid upstream of this process and the three energy-consuming and heat-producing turbomachines, B100, C600, and C900. The process flow diagram illustrates heat recovery from each of the turbomachines with dashed lines leading to a heat exchanger immediately prior to the expander. The warm and somewhat pressurized process fluid at this point exits through the expander where it cools, making use of the low-grade heat available internally and externally in this process.

Examples of systems that this invention can treat include but are not limited to: CO₂ removal from process fluids such as air, flue gas, syngas, natural gas, biogas, and process gas; H₂O removal from most moisture-carrying gases; SOx removal from vitiated flows and other sulfur-containing gases; and absorption/condensation of any gas component by a contact liquid capable of absorbing some portion of the component.

Embodiments of the disclosure can produce up to 99.999% pure CO₂.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for separating carbon dioxide from a process fluid stream comprising:
a. a process fluid feed line;
b. a dryer contact liquid feed line;
c. a drying heat exchanger having a combined stream cooling passage and a refrigeration passage;
d. a junction configured to combine a process fluid from the process fluid feed line and a dryer contact liquid from the dryer contact liquid feed line so that a combined stream containing a dryer contact liquid portion, a dryer contact vapor portion and the process fluid is formed and directed to the combined stream cooling passage;
e. said combined stream cooling passage and the refrigeration passage configured so that a coolant stream in the refrigeration passage reduces a temperature of the combined stream so that water from the process fluid and at least a portion of the dryer contact vapor portion condense and combine with the dryer contact liquid portion to form a combined liquid stream;
f. a combined stream phase separator configured to receive and separate the combined liquid stream from the combined stream cooling passage into a gaseous process fluid stream and a wet dryer contact liquid stream;
g. an extraction heat exchanger having a carbon dioxide extraction cooling passage and an extraction heat exchanger refrigerant warming passage, said carbon dioxide extraction cooling passage having a gaseous process fluid inlet, a treated process fluid outlet, an extraction contact liquid inlet configured to receive an extraction contact liquid and a carbon dioxide enriched extraction contact liquid outlet, and said extraction heat exchanger refrigerant warming passage configured to receive a first refrigerant or a second refrigerant for cooling the carbon dioxide extraction cooling passage;
h. a gaseous process fluid line configured to direct gaseous process fluid from the combined stream phase separator to the gaseous process fluid inlet of the carbon dioxide extraction cooling passage of the extraction heat exchanger;
i. said carbon dioxide extraction cooling passage of the extraction heat exchanger configured so that extraction contact liquid therein contacts gaseous process fluid so that carbon dioxide is extracted from the gaseous process fluid to form a treated process fluid and a carbon dioxide enriched extraction contact liquid, where the treated process fluid exits the carbon dioxide extraction cooling passage through the treated process fluid outlet and the carbon dioxide enriched extraction contact liquid exits the carbon dioxide extraction cooling passage through the carbon dioxide enriched extraction contact liquid outlet.

2. The system of claim 1 wherein the carbon dioxide extraction cooling passage of the extraction heat exchanger is configured so that the extraction contact liquid flows counter-current to the gaseous flue gas therein.

3. The system of claim 1 further comprising a wet dryer contact liquid line configured to direct a wet dryer contact liquid stream from the combined stream phase separator to the at least one refrigeration passage of the drying heat exchanger to provide cooling for the combined stream cooling passage.

4. The system of claim 1, further comprising a treated process fluid line configured to direct a treated process fluid from the treated process fluid outlet of the extraction heat exchanger to the refrigeration passage of the drying heat exchanger to provide cooling for the combined stream cooling passage.

5. The system of claim 1 wherein the combined stream phase separator is incorporated into the drying heat exchanger.

6. The system of claim 1 wherein the combined stream phase separator is a flash vessel configured to receive the combined stream from the drying heat exchanger and separate the combined stream into a gaseous process fluid stream and a wet dryer contact liquid stream.

7. The system of claim 1 further comprising a first feed stream cooling heat exchanger configured to receive a process fluid feed stream and a first cooling fluid stream so that the process fluid feed stream is cooled by the first cooling fluid stream, said first feed stream cooling heat exchanger having a first wet process fluid feed stream outlet in fluid communication with the process fluid feed line.

8. The system of claim 7 further comprising:
j. a second feed stream cooling heat exchanger having a wet process fluid inlet in fluid communication with the first wet process fluid feed stream outlet of the first feed stream cooling heat exchanger and a cooled cooling water inlet configured to receive a cooled cooling water stream so that a flue gas feed stream is cooled by direct contact with the cooled cooling water stream in the second feed stream cooling heat exchanger and so that a warmed cooling water stream is produced, said second feed stream cooling heat exchanger having a second wet process fluid feed stream outlet in fluid communication with the process fluid feed line;
k. a third feed stream cooling heat exchanger configured to receive the warmed cooling water stream from the second feed stream cooling heat exchanger and a treated process fluid stream inlet in fluid communication with the treated process fluid outlet of the extraction heat exchanger and to directly contact and cool the received warmed cooling water stream so that a cooled cooling water stream is produced, said third feed stream cooling heat exchanger having a cooled cooling water stream outlet in fluid communication with the cooled cooling water inlet of the second feed stream cooling heat exchanger.

9. The system of claim 8 further comprising a cooled cooling water pump configured to pump cooled cooling water from the cooled cooling water stream outlet of the second feed stream cooling heat exchanger to the cooled cooling water inlet of the second feed stream cooling heat exchanger.

10. The system of claim 8 further comprising a cooled process fluid feed stream compressor having an inlet in fluid communication with the first wet process fluid feed stream outlet of the first feed stream cooling heat exchanger and an outlet in fluid communication with the wet process fluid inlet of the second feed stream cooling heat exchanger.

11. The system of claim 1 further comprising:
j. a wet dryer contact liquid line configured to direct a wet dryer contact liquid stream from the combined stream phase separator to the refrigeration passage of the drying heat exchanger to provide cooling for the combined stream cooling passage;
k. a dryer distillation column having a distillation column inlet in fluid communication with an outlet of the refrigeration passage, said dryer distillation column also having a dryer distillation column treated contact liquid outlet and a dryer distillation column water outlet, said dryer distillation column configured to receive and separate wet dryer contact liquid from the outlet of the refrigeration passage of the drying heat exchanger into a dryer contact liquid stream, which is directed out of the treated contact liquid outlet, and a reboiler outlet stream which is directed out of the dryer distillation column water outlet.

12. The system of claim 11 further comprising a dryer distillation column heat exchanger configured to receive and cool a reboiler outlet stream from the dryer distillation column and to receive and warm wet dryer contact liquid from the outlet of the refrigeration passage of the drying heat exchanger and direct and to direct warmed wet dryer contact liquid to the dryer distillation column inlet.

13. The system of claim 11 wherein the dryer distillation column further includes a dryer contact vapor outlet and wherein dryer contact vapor is formed in the dryer distillation column and directed through the dryer contact vapor outlet.

14. The system of claim 1 wherein the dryer contact liquid includes alcohol.

15. The system of claim 1 wherein the dryer contact liquid includes a component selected from the group consisting of water, methanol, ethanol, propanol, ketones and inorganic fluids.

16. The system of claim 15 wherein the extraction contact liquid includes a component selected from the group consisting of ketones, alcohols, ethers, and acetates.

17. The system of claim 1 wherein the dryer contact liquid includes an ether selected from the group consisting of dimethyl ether, diethyl ether and methyl-ethyl ether.

18. The system of claim 1 wherein the dryer contact liquid includes an inorganic fluid selected from the group consisting of ammonia and low-melting-point amines.

19. The system of claim 1 wherein the extraction contact liquid includes a component selected from the group consisting of ketones, alcohols, ethers, and acetates.

20. The system of claim 1 wherein the junction is positioned within the drying heat exchanger.

21. The system of claim 1 wherein the junction is positioned upstream from the drying heat exchanger.

22. The system of claim 1 wherein the drying heat exchanger includes a header and the junction is positioned within the header.

23. The system of claim 1 wherein the combined stream cooling passage of the drying heat exchanger includes a combined stream cooling passage channel that is configured so that a dryer contact liquid stream wets a surface of the combined stream cooling passage channel but leaves an open volume in the combined stream cooling passage channel for a process fluid stream to pass.

24. The system of claim 1 wherein said coolant stream is selected from the group consisting of the wet dryer contact liquid stream from the combined stream phase separator, the treated process fluid from the treated process fluid outlet of the extraction heat exchanger, the first refrigerant and a separate refrigerant.

25. The system of claim 1 wherein the carbon dioxide extraction cooling passage of the extraction heat exchanger includes a carbon dioxide extraction cooling passage channel that is configured so that an extraction contact liquid stream wets a surface of the carbon dioxide extraction cooling passage channel but leaves an open volume in the carbon dioxide extraction cooling passage channel for a gaseous process fluid stream to pass.

26. The system of claim 1 further comprising:
j. a refrigerant heat exchanger including a refrigerant cooling passage in fluid communication with the refrigeration passage of the drying heat exchanger and the extraction heat exchanger refrigerant warming passage, a carbon dioxide enriched extraction contact liquid warming passage in fluid communication with the carbon dioxide enriched extraction contact liquid outlet of the extraction heat exchanger and an extraction contact liquid cooling passage in fluid communication with the extraction contact liquid inlet of the extraction heat exchanger;
k. an extraction distillation column having a carbon dioxide enriched extraction contact liquid inlet in fluid communication with the carbon dioxide enriched extraction contact liquid warming passage of the refrigerant heat exchanger, a carbon dioxide liquid outlet, an extraction contact liquid outlet in fluid communication with the extraction contact liquid cooling passage of the refrigerant heat exchanger;
l. said extraction distillation column configured to separate a warmed carbon dioxide enriched extraction contact liquid stream received from the carbon dioxide enriched extraction contact liquid warming passage of the refrigerant heat exchanger into a carbon dioxide liquid stream, which is directed out of the extraction distillation column through the carbon dioxide liquid outlet, and an extraction contact liquid stream, which is directed out of the extraction distillation column through the extraction contact liquid outlet.

27. The system of claim 26 wherein the refrigerant heat exchanger includes a liquid carbon dioxide cooling passage and further comprising a liquid carbon dioxide pump configured to pump liquid carbon dioxide from the carbon dioxide liquid outlet of the extraction distillation column to the liquid carbon dioxide cooling passage of the refrigerant heat exchanger.

28. The system of claim 1 wherein the dryer contact liquid generates a sufficient dryer contact vapor portion such that the condensation of at least a portion of the dryer contact vapor portion and water vapor results in the combined liquid stream remaining above a melting point of the combined liquid stream at all temperatures present in the dryer.

29. A system for separating carbon dioxide from a flue gas stream comprising:
a. a process fluid feed line;
b. an extraction heat exchanger having a carbon dioxide extraction cooling passage and an extraction heat exchanger refrigerant warming passage, said carbon dioxide extraction cooling passage having a process fluid inlet in fluid communication with the process fluid feed line, a treated process fluid outlet, an extraction contact liquid inlet configured to receive an extraction contact liquid and a carbon dioxide enriched extraction contact liquid outlet;
c. said carbon dioxide extraction cooling passage of the extraction heat exchanger configured so that extraction contact liquid therein contacts process fluid so that carbon dioxide is extracted from the process fluid to form a treated process fluid and a carbon dioxide enriched extraction contact liquid, where the treated process fluid exits the carbon dioxide extraction cooling passage through the treated process fluid outlet and the carbon dioxide enriched extraction contact liquid exits the carbon dioxide extraction cooling passage through the carbon dioxide enriched extraction contact liquid outlet.

30. The system of claim 29 wherein the extraction heat exchanger includes an extraction heat exchanger refrigerant warming passage configured to receive a refrigerant for cooling the carbon dioxide extraction cooling passage.

31. A method for separating carbon dioxide from a process fluid stream comprising the steps of:
a. combining a process fluid stream and a dryer contact liquid stream to provide a combined stream;
b. directing the combined stream through a drying heat exchanger;
c. cooling the combined stream in the drying heat exchanger by warming a coolant stream;
d. condensing water from the process fluid stream into the dryer contact liquid stream in the drying heat exchanger;
e. separating the combined stream into a gaseous process fluid stream and the wet dryer contact liquid stream;
f. contacting the gaseous process fluid stream with an extraction contact liquid stream within an extraction heat exchanger so that carbon dioxide is transferred from the gaseous process fluid stream to the extraction contact liquid and a treated process fluid stream and a carbon dioxide enriched extraction contact liquid stream are produced;
g. warming a first refrigerant or a second refrigerant within the extraction heat exchanger so that the contacting gaseous process fluid stream and the extraction contact liquid stream are cooled in the extraction heat exchanger.

32. The method of claim 31 wherein the coolant stream of step c. is selected from the group consisting of the treated process fluid stream, the wet dryer contact liquid stream and the first refrigerant stream.

33. The method of claim 31 wherein the extraction contact liquid flows counter-current to the gaseous process fluid within the extraction heat exchanger during step f.

34. The method of claim 31 wherein the dryer contact liquid includes alcohol.

35. The method of claim 31 wherein the dryer contact liquid includes a component selected from the group consisting of water, methanol, ethanol, propanol, ketones and inorganic fluids.

36. The method of claim 35 wherein the extraction contact liquid includes a component selected from the group consisting of ketones, alcohols, ethers, and acetates.

37. The method of claim 31 wherein the dryer contact liquid includes an ether selected from the group consisting of dimethyl ether, diethyl ether and methyl-ethyl ether.

38. The method of claim 31 wherein the dryer contact liquid includes an inorganic fluid selected from the group consisting of ammonia and low-melting-point amines.

39. The method of claim 31 wherein the extraction contact liquid includes a component selected from the group consisting of ketones, alcohols, ethers, and acetates.

40. The method of claim 31 wherein combination of the process fluid stream and the dryer contact liquid stream occurs within the drying heat exchanger.

41. The method of claim 31 wherein combination of the process fluid stream and the dryer contact liquid stream occurs upstream of the drying heat exchanger.

42. The method of claim 31 wherein step e. occurs within the drying heat exchanger.

43. The method of claim 31 wherein step e. occurs in a flashing vessel.

44. The method of claim 31 further comprising the step of cooling the process fluid stream with a fluid prior to step a.

45. The method of claim 44 further comprising the step of cooling the process fluid stream with fluid in a first feed stream cooling heat exchanger and a second feed stream cooling heat exchanger prior to step a.

46. The method of claim 45 further comprising the step of compressing the process fluid stream between the first and second feed stream cooling heat exchangers.

47. The method of claim 31 further comprising the step of separating the wet dryer contact liquid stream from the drying contact heat exchanger into the dryer contact liquid stream and a waste water stream.

48. The method of claim 47 further comprising the step of cooling the wet dryer contact liquid stream from the drying heat exchanger using the waste water stream.

49. The method of claim 31 further comprising the steps of:
h. cooling the first refrigerant in the refrigerant heat exchanger;
i. warming the carbon dioxide enriched extraction contact liquid stream in a refrigerant heat exchanger;
j. separating the warmed carbon dioxide enriched extraction contact liquid stream in an extraction distillation column into a carbon dioxide liquid stream and the extraction contact liquid stream;
k. cooling the extraction contact liquid stream from the extraction distillation column in the refrigerant heat exchanger and directing the cooled extraction contact liquid stream from the refrigerant heat exchanger to the extraction heat exchanger.

50. The method of claim 49 wherein the liquid carbon dioxide is warmed in the refrigerant heat exchanger.

51. The method of claim 31 wherein during step g., carbon dioxide from the gaseous process fluid stream is condensed into the extraction contact liquid.

52. The method of claim 31 wherein during step f., carbon dioxide from the gaseous process fluid stream is absorbed into the extraction contact liquid.
